(19) United States
(12) Patent Application Publication
(10) Pub. No.: US 2007/0282496 A1
(43) Pub. Date: Dec. 6, 2007

(54) Service provision system or provision method for providing various services including diagnosis of a mobile body and portable information equipment used for the system

(75) Inventor: Yasuaki Morimoto, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: Fujitsu Limited, Kawasaki-shi (JP)

(21) Appl. No.: 11/890,370

(22) Filed: Aug. 6, 2007

Related U.S. Application Data
(63) Continuation of application No. PCT/JP05/02064, filed on Feb. 10, 2005.

(51) Int. Cl. G01M 17/00; B60Q 1/00; G06F 19/00

(52) U.S. Cl. 701/29; 340/425.5; 340/438

(57) ABSTRACT

A mobile body obtains information from an in-vehicle sensor related to the operating condition and obtains information from a navigation system as correlated information. Application software is introduced to a portable information equipment at the time of signing up for a contract for receiving a service of the present service provision system when purchasing the mobile body. A user terminal is permitted to install various kinds of application software provided by a service provision entity, and information stored in the portable information equipment is got in the terminal by linking therewith. The service provision entity receives and analyzes the information got in the user terminal and provides a service including a diagnosis of the mobile body.

### CROSS REFERENCE TO RELATED APPLICATION

This application is a continuation of the PCT application PCT/JP2005/002064 which was filed on Feb. 10, 2005.

### BACKGROUND OF THE INVENTION

1. Field of the Invention

The present invention relates to a service provision system for providing various services including a diagnosis by obtaining information related to an operating condition of a mobile body and obtaining information received from a navigation system, and in particular to a service provision system obtaining information related to an operating condition of a mobile body and one received from a navigation system as correlated information, transmitting the obtained information to a service provision entity by getting it in a user terminal via a portable information equipment and receiving a provision of service including a diagnosis service of the mobile body.

2. Description of the Related Art

FIG. 1 is a diagram showing a conventional mobile information service system utilizing a portable information equipment. In the conventional mobile information service system put forth in the following reference patent document 1, a portable information equipment (e.g., personal digital assistant (PDA)) held by a user riding in an automobile 51 receives the latest road, weather, and destination information provided by a information provision service company 50. And a self-diagnosis function equipped in an automobile 51 analyzes positional information of the automobile 51 acquired by a navigation system 52 and data from various sensors equipped in the automobile 51. The portable information equipment transmits the analysis information in real time to the information provision service company 50 and automobile company 57, while the automobile company 57 constantly monitors an operating condition(s) of the user's automobile 51. Based on the analysis information, it provides the user with appropriate information in accordance with the condition(s) via the portable information equipment (e.g., PDA) carried with the user as shown in FIG. 1. A major characteristic of the conventional technique lies in the self-diagnosis function equipped in the automobile 51, pre-analyzing data acquired by various sensors equipped therein, and transmitting the analysis result constantly to the information provision service company 50 and automobile company 57 so as to enable the portable information equipment (e.g., PDA) possessed by the user to constantly receive the appropriate information.

FIG. 2 is a diagram showing a conventional vehicle information management system following up on a maintenance check of a vehicle by building up a system for exchanging a user's vehicle data of a vehicle 65 between a user terminal 66 and a vehicle information management company. The conventional vehicle information management system, put forth by the below-noted reference patent document 2, is configured to store vehicle data in memory card 68 by taking the data out of an electronic control unit 67, transferring the vehicle data stored in the memory card 68 to a hard disk on a user terminal personal computer (PC) 66, and acquiring diagnosis information on a Web display screen by having user's terminal PC 66 open the user specific home page 70 provided by the vehicle information management company that manages the user's vehicle information, by way of the Internet 64, as shown in FIG. 2. Patent document 2 has further disclosed a real time diagnosis service that is configured to transfer vehicle data to a portable phone from a data extraction means equipped in the electronic control unit itself by way of a short distance radio communication means and display the diagnosis information on a Web screen of the portable phone in place of the Web screen of the user specific home page on the terminal PC 66.

Patent document 1: Laid-Open Japanese Patent Application Publication No. 2002-230658

Patent document 2: Laid-Open Japanese Patent Application Publication No. 2003-011747

### SUMMARY OF THE INVENTION

In the conventional example described above, however, a consecutive diagnostic analysis of self-diagnosis data equipped in an automobile performed by an automobile company and a transmission of the diagnosis result to a portable information equipment of the user do not provide a distinct time separation of diagnosis data and therefore a consecutive transmission of the diagnosis result tends to foster uneasiness of the user because the contradictory messages such as “good condition” and “bad condition” may alternately be sent out, and besides, a diagnosis system at the car maker and a system at the information provision company are faced with a problem of becoming complex just because the systems operate in real time.

Another problem with the above-described conventional example is that a communication cost at the service provision company or automobile company becomes probably enormous for transmitting pieces of diagnosis information consecutively to the terminal or portable terminal of the user.

Yet another problem with the above-described conventional example is that, if a real time diagnosis result is issued in the middle of a driving, requiring a replacement of a part, the part may scarcely be available at a repair shop nearby.

Yet another problem with the above-described conventional example is that a portable information equipment does not have the function to directly import raw data from various sensors equipped in an automobile therefore it's capability of adequately diagnosing and analyzing is doubtful.

Yet another problem with the above-described conventional example is that a portable information equipment enable to transmit and receive at a certain time interval, and therefore a communication expense of the user, combined with a contract fee and an annual membership fee, is large even though a communication cost is reduced these days.

Yet another problem with the above-described conventional example is that the means for accumulating a large volume of position information and vehicle window photographs along with sensor data, getting these pieces of data in a home or office personal computer (PC) and easily enjoying drive history (i.e., a trip album) along with map information is not retained.

In order to solve the problems described above, the present invention aims to provide a service provision system or provision method, for correlating information related to an operating condition obtained from a mobile body and one received from a navigation system, transmitting the information to a service provision entity by getting the information in a user terminal via a portable information equipment and receiving a provision of service including a diagnosis, and aims at providing a portable information equipment used for the system.

In order to solve the above-described problem, the present invention comprises a mobile body for obtaining information related to an operating condition from an in-vehicle sensor and one received from a navigation system one after another as correlated information; a portable information equipment, in which application software is introduced at the time of signing up a contract, for storing the information on a storage medium; a user terminal in which various kinds of application software, of a service provision entity, for getting the information in a terminal by linking with the portable information equipment is installed; and a service provision entity for receiving, and analyzing, the information got in the user terminal and providing a service including a diagnosis of the mobile body.

The present invention is contrived to store the obtained information related to an operating condition and the information obtained from the navigation system, as correlated information, within a user portable information equipment, transmit the stored information related to an operating condition and the information obtained from the navigation system, as correlated information, to the diagnosis system of the service provision entity via the user terminal and receive the diagnosis result via the Web, thereby providing a benefit of making it possible to reduce a telecommunication costs of the user of a diagnosis service, and also enable the service provision entity to build up a database using the raw data of the mobile body and contribute to the development and improvement thereof.

### BRIEF EXPLANATION OF THE DRAWINGS

FIG. 1 is a diagram showing a conventional mobile information service system utilizing a portable information equipment;

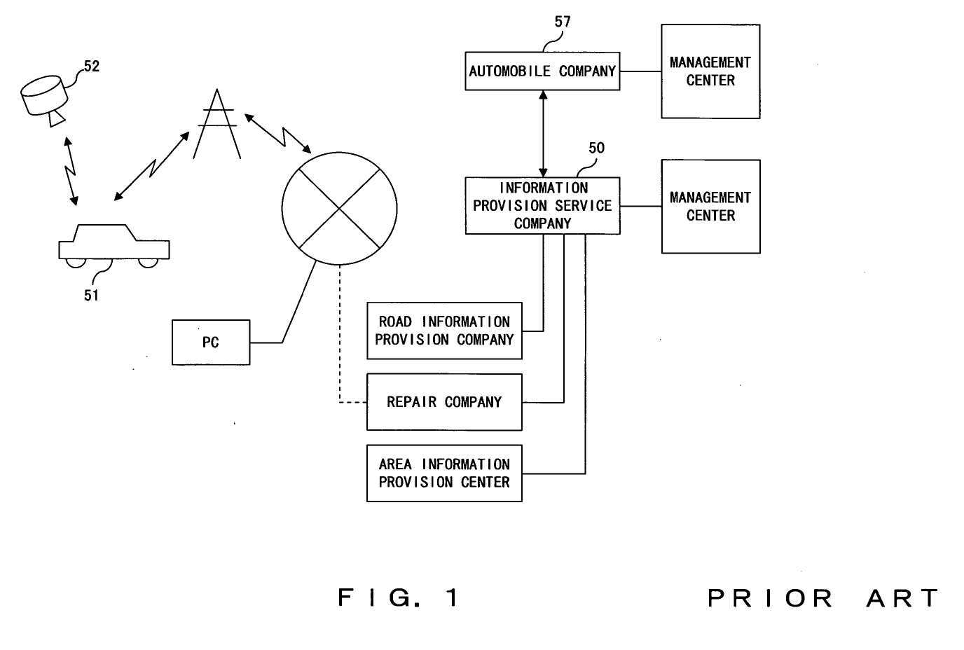

FIG. 2 is a diagram showing a conventional vehicle information management system utilizing a user terminal;

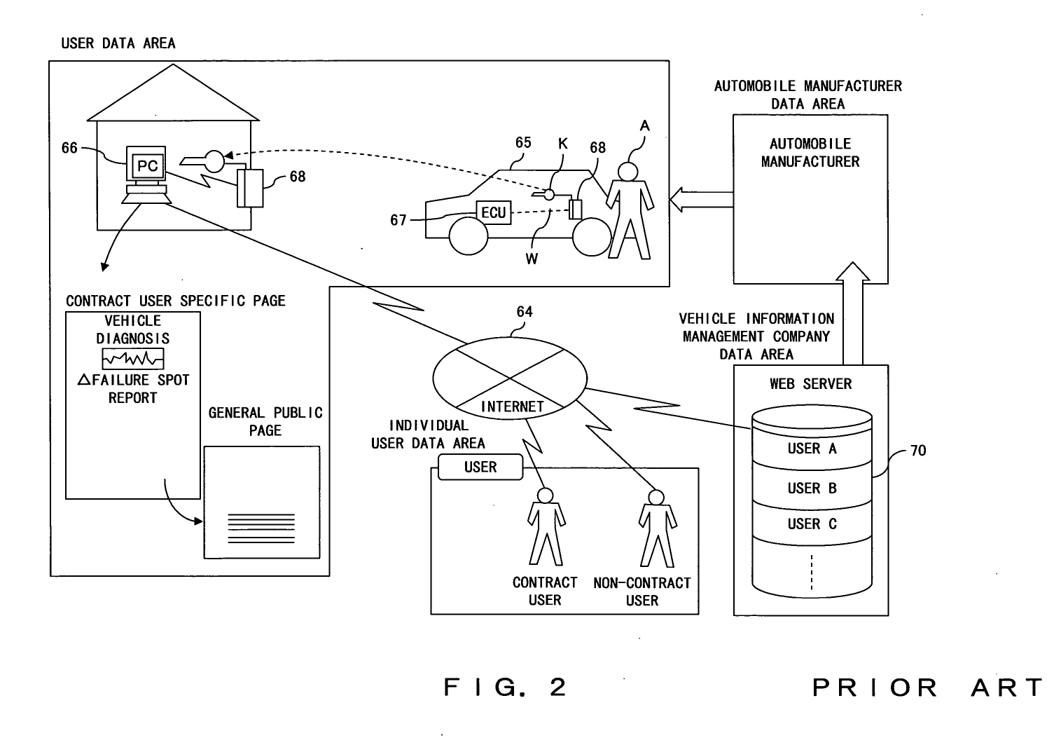

FIG. 3 is a diagram of a service provision system configuration, including a diagnosis according to a preferred embodiment of the present invention;

FIG. 4 is a diagram describing, in further detail the content of the procedure shown by block A of FIG. 3;

FIG. 5 is a flow chart diagram of the procedure at an affiliated dealer shown by block A of FIG. 3;

FIG. 6 is a diagram further describing the major operation of the system in an automobile run scene shown by block B of FIG. 3;

FIG. 7 is a flow chart diagram of a system operation of an automobile run scene shown by block B of FIG. 3;

FIG. 8 is a diagram showing a situation wherein an action is taken to a diagnosis system provided by an automobile manufacturer from a user's home PC shown by block C of FIG. 3;

FIG. 9 is a flow chart diagram of an operation for requesting a diagnosis service at the home of the PC shown in FIG. 8;

FIG. 10 is a diagram showing a configuration of an automobile manufacturer diagnosis system according to a preferred embodiment of the present invention;

FIG. 11 is a block diagram showing acquired data being processed from a portable phone, a car A/V (including a car navigation system) and an automobile, while the automobile is traveling, which is in accordance with a preferred embodiment of the present invention;

FIG. 12 is a flow chart diagram describing a retrospect scene creation service as an example of a non-diagnosis service provision according to a preferred embodiment of the present invention;

FIG. 13 is a diagram showing a first business model, which is generated when the service provision body is an automobile manufacturer according to a preferred embodiment of the present invention;

FIG. 14 is a diagram showing a second business model in which a service provision support company is separately established, according to a preferred embodiment of the present invention, in order to comprehend the first business model shown in FIG. 13, and further develop from that business model;

FIG. 15 is a diagram for describing a third business model in an attempt to cooperate with a non-life insurance company according to a preferred embodiment of the present invention;

FIG. 16 is a diagram showing a fourth business model in which a service provision support company is separately established according to a preferred embodiment of the present invention in order to comprehend the third business model shown in FIG. 15 and further develop from that business model;

FIG. 17 is a functional block diagram related to a first embodiment for implementing an emergency communication in the service provision system according to the present invention;

FIG. 18 is a functional block diagram related to a second embodiment for implementing an emergency communication in the service provision system according to the present invention;

FIG. 19 is a block diagram showing a configuration for making a hard disk, that is including in the car's A/V navigation system, a diagnosis data storage medium in the service provision system of the present invention; and

FIG. 20 is an enlarged diagram showing the configuration of the hard disk shown in FIG. 19.

### DESCRIPTION OF THE PREFERRED EMBODIMENTS

The following is a description of the preferred embodiment of the present invention by referring to the accompanying drawings.

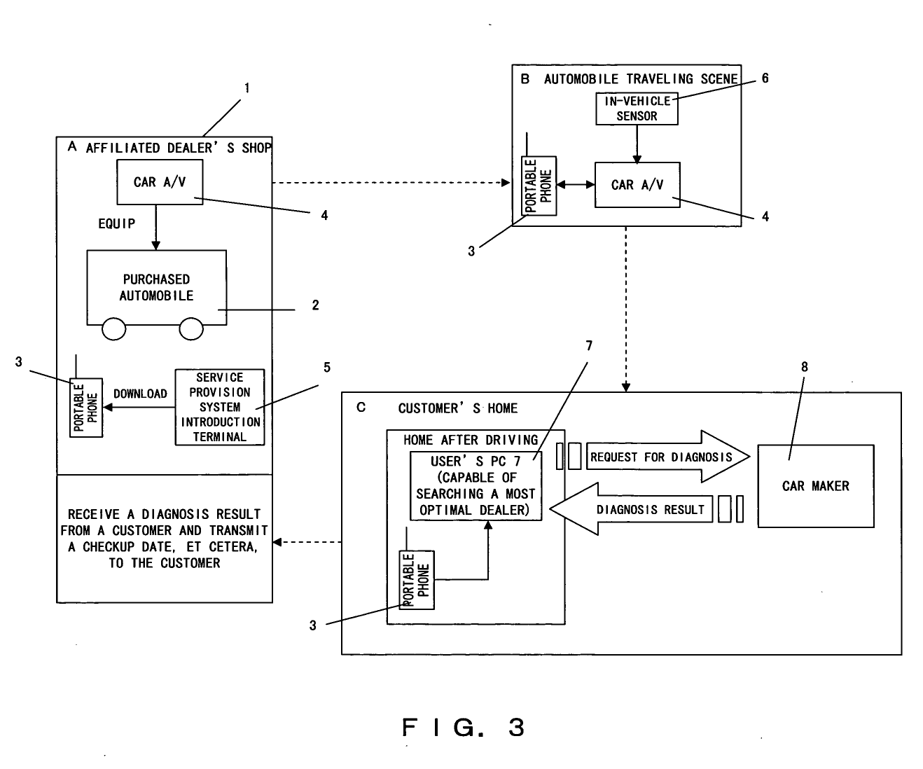

FIG. 3 is a conceptual diagram of a configuration of a service provision system including a diagnosis according to a preferred embodiment of the present invention. The present embodiment is described by exemplifying a portable phone as a portable information equipment, for example, the equipment may be a personal digital assistant (PDA) or such. It is also described by exemplifying a vehicle, (e.g., an automobile), as a mobile body that is a diagnosed piece of equipment; however, the equipment may be heavy construction machine, a vessel, a flying body, et cetera, in lieu of being limited to an automobile. The equipment may also be applicable to a personal use or a business use. Meanwhile, it is described by exemplifying an automobile manufacturer producing vehicles as a service provision entity, and further exemplifying the case of furnishing an affiliated dealer selling vehicles of the aforementioned automobile manufacturer with a service provision system introduction terminal.

Block A of FIG. 3 is a diagram showing a shop scene of an affiliated dealer 1 for a customer user purchasing an automobile 2, where the user enters into a contract for purchasing the automobile 2 and a service contract including a diagnosis related to an operation condition of a mobile body in correlation with data acquired from a portable phone 3 and a car audio/video apparatus (A/V) 4 (including a car navigation system). Under this contract, application software enables the importation of data necessary for implementing a service, including diagnosis. This application software is installed onto the portable phone 3 possessed by the user from a service provision system introduction terminal 5 installed at the affiliated dealer's 1 shop.

Block B of FIG. 3 is a diagram showing a scene of a user driving an automobile with a portable phone 3 placed at a prescribed position of the vehicle (e.g., a portable phone connection box or holder placed on the dash board). Raw data from various sensors, that is, an in-vehicle sensor 6, equipped in an automobile 2 and information such as latitude, longitude, geographical name, road number, et cetera, are put together and transmitted from a car A/V 4 to a portable phone 3. In this case, the aforementioned data and information are converted into a prescribed format and stored in a storage medium comprised by a portable phone 3. A configuration of the storage medium comprised by a portable phone 3 is described later.

Block C of FIG. 3 is a diagram showing a scene of a diagnosis service request after a user leaves an automobile 2 behind and comes home carrying a portable phone 3 with her/him. The user makes a home PC 7 call a diagnosis system by opening a Web page that enables access to the diagnosis service provided by the automobile manufacturer 8 (hereinafter abbreviated as “car maker”) by way of the Internet, transfers data for a diagnosis (hereinafter named as “diagnosis data”) stored in the storage medium of a portable phone 3 to a PC 7, and requests the diagnosis system provided by a car maker 8 for a diagnosis service. A Web function provided by a car maker 8 is described in detail later. Note that the diagnosis service request can also be made from her/his office if there is a specific PC available, and not only from a home.

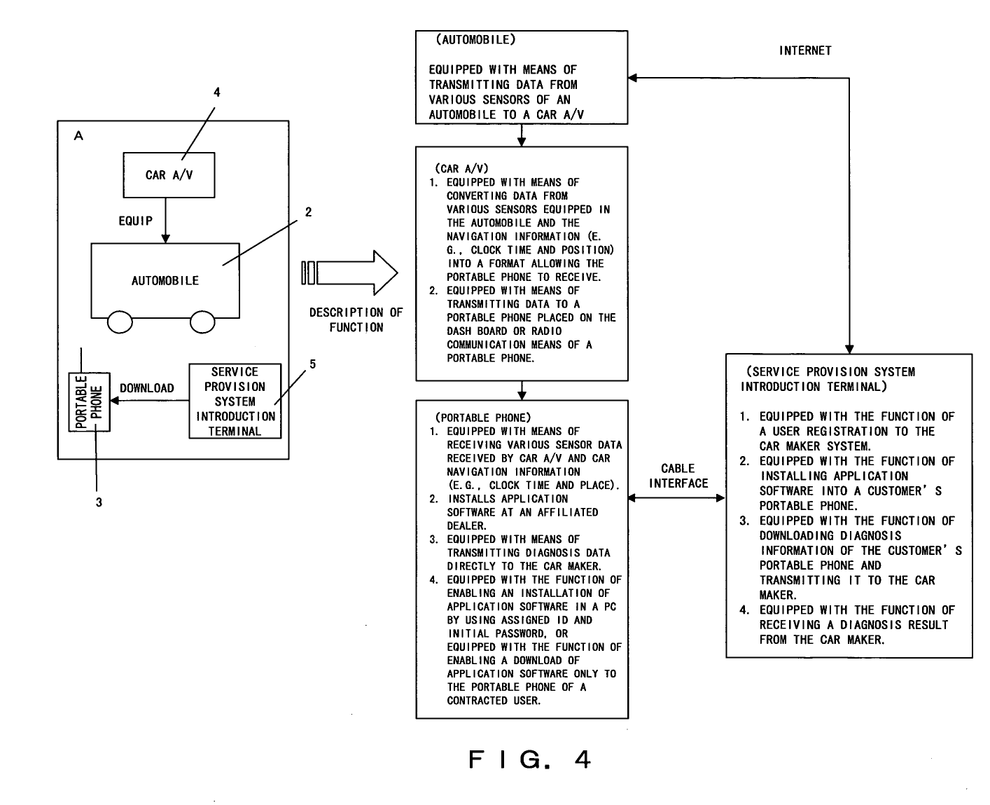

FIG. 4 is a diagram describing the content of the procedure shown by block A of FIG. 3. A means of transmitting in-vehicle sensor data to the car A/V 4 is preinstalled when the automobile is manufactured. The car A/V 4 is equipped with means for converting data from various sensors equipped in the automobile 2 as well as navigational information (e.g., latitude and longitude) into a format that a portable phone 3 may receive. The affiliated dealer delivers an automobile 2 to the user with the means of transmitting and means for converting already equipped. Also, at the time of contracting, the present service may install application software on the portable phone 3 of the user by connecting the portable phone 3 to the service provision system introduction terminal 5 via a cable interface such as a Universal Serial Bus (USB) and RS232C for receiving various sensor data of the automobile 2. Also, user identification information (e.g., ID and password) is assigned to the user for accessing a car maker's 8 Web page so that the user can register with the car maker. The user receives this present service by accessing a car maker's 8 Web page by using the ID and password that was assigned to the user in her/his user identification information. Furthermore, the portable phone 3 is furnished with the function of transmitting the diagnosis information stored in the portable phone 3 to the car maker 8 directly. The service provision system introduction terminal 5 is furnished with the function of receiving a diagnosis result from the car maker 8.

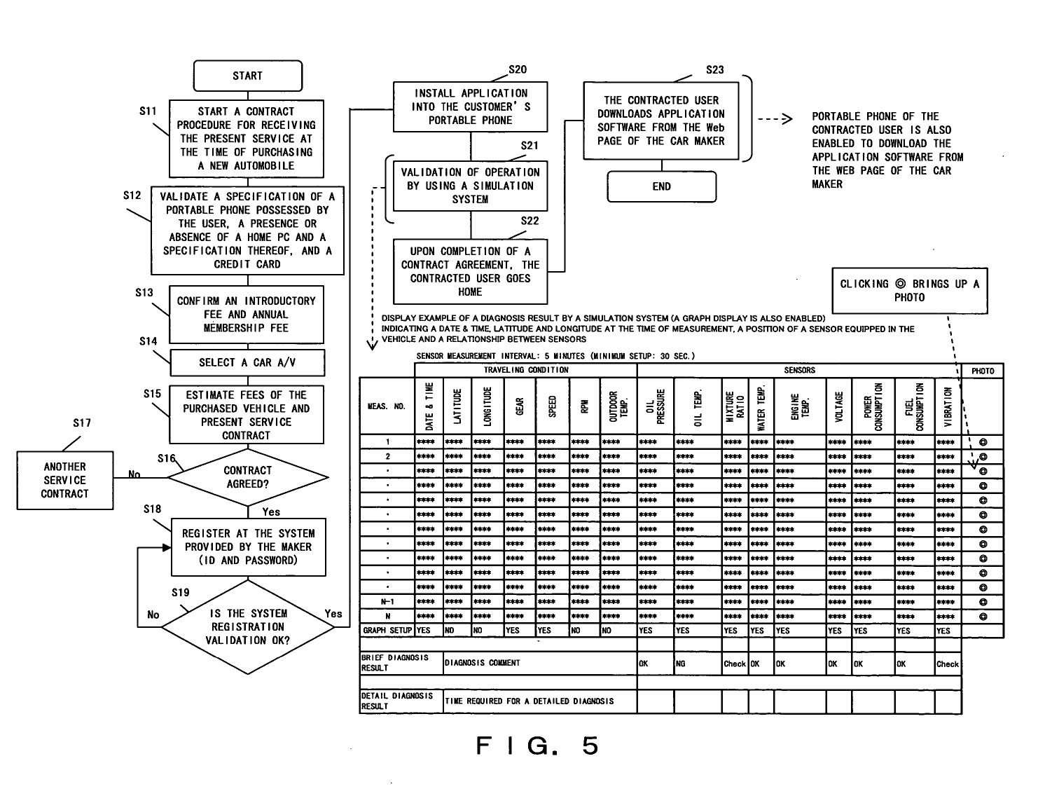

FIG. 5 is a flow chart diagram of the procedure at an affiliated dealer as shown by block A of FIG. 3. The user starts a contract procedure for receiving a service from a service provision system (sometimes abbreviated as “service” hereinafter) including diagnosis provided by the car maker at the time of purchasing a new automobile (S11). Next is a validation of the user's portable phone 3 specification, the presence or absence of a home PC 7 and a specification thereof, and a credit card or other payment method (S12). Next there is an explanation of the contract fee (i.e., an introductory fee) and an annual membership fee, and a confirmation of the contract content of the present service (S13). Next, a car A/V (S14) is selected and a total fee including the purchased vehicle and the present service contract (S15) is estimated. Finally, this is followed by entering into a contract (S16). Possible variations, such as failure to contract, of if the user signs up for another service contract, are not discussed because they are outside the scope of the present invention (S17). When the user agrees to the contract, a registration in the system provided by the car maker 8 is carried out and user identification information (e.g., ID and password) is issued (S18). Next, the system registration is validated via a service provision system introduction terminal 5 (S19). In this event, the service provision system introduction terminal 5 is connected to a portable phone 3 by way of a USB or RS232C interface cable and application software is installed on the portable phone 3 (S20). The application software is configured to store, in a storage medium comprised by the portable phone 3, data from various sensors equipped in the vehicle and a car window picture and such taken by the portable phone 3 in accordance with a prescribed data format. Next there is a validation of the car maker's 8 entire system, including a Web access, using the portable phone 3 on which the application software is installed. This application software operates by using a simulation system furnished in the service provision system introduction terminal 5. The lower part of FIG. 5 shows a display example of a diagnosis result based on the simulation system, that is, a display example of a diagnosis result of incorporating car navigation information, in-vehicle sensor data, and car window picture photographing conditions. This display example shows the diagnosis result in the form of converting the data array so as to indicate the date & time, the latitude and longitude at the time of measurement, the position of the sensor equipped in the vehicle, and the relationship between sensors as a result of the introduction of the application software. Upon completing the validation of the operation using the simulation system, the entire contract procedure is complete (S21). Upon completion of the contract agreement, the user goes home (S22), accesses the car maker's 8 Web page by using the ID and password assigned to the user in the user identification information, and confirms the registration. Upon completion, the user is enabled to download the application software onto a home PC (S23). The user is also enabled to confirm the registration and download the application software from the contracted user's portable phone 3. This illustrates the sequence of events when entering into a service contract.

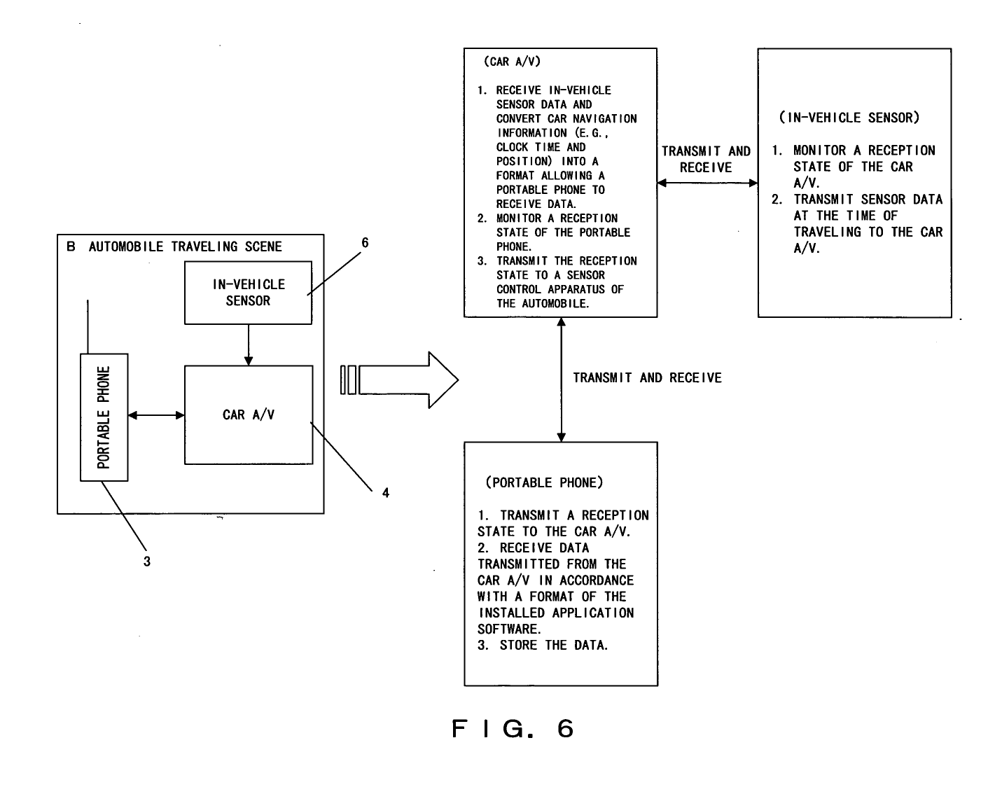

FIG. 6 is a diagram describing a major operation of the system in an automobile run scene as shown by block B of FIG. 3. The in-vehicle sensor 6 monitors a reception state of a car A/V 4 and also transmits sensor data to a car A/V 4 at the time of a run. While monitoring a reception state of the portable phone 3, the car A/V 4 converts car navigation information (e.g., latitude, longitude, and such) and in-vehicle sensor data into a format allowing the portable phone 3 to receive and transmit at a data transmission interval set by the user. Meanwhile, the car A/V 4 transmits the reception state of the car A/V from the in-vehicle sensor data to a sensor control apparatus of the automobile. The portable phone 3 transmits a reception state to the car A/V 4 and converts the in-vehicle sensor data and transmitted data from the car A/V 4 into a data array, in accordance with a prescribed format, and stores the data in a storage medium (not shown herein). The portable phone's 3 storage medium stores the photographed car window picture, the car navigation information (e.g., latitude and longitude), and the in-vehicle sensor data.

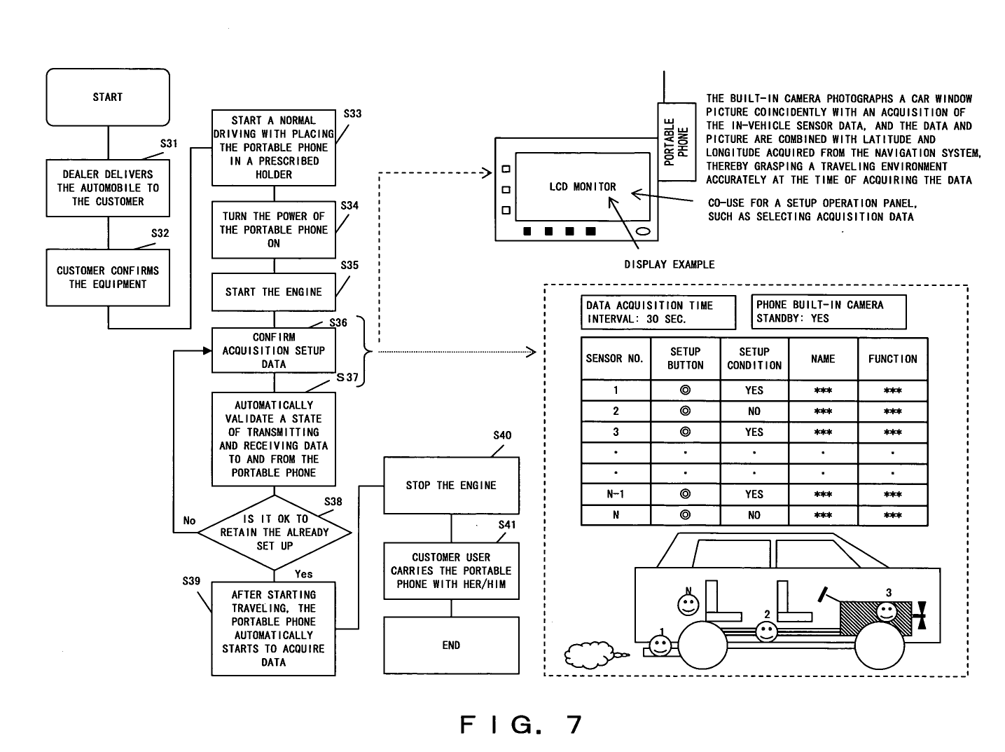

FIG. 7 is a flow chart diagram of a system operation of the system in an automobile run scene as shown by block B of FIG. 3. First, the dealer 1 delivers the automobile to the customer user (S31). Following a confirmation of the automobile's 2 equipment, which was delivered by a dealer 1 (S32), normal driving (i.e., a run) may begin by placing a portable phone 3 in a prescribed holder (S33). When a portable phone 3 is placed in the prescribed holder, the battery capacity is increased by means of a recharging function for the portable phone 3. If there is enough battery capacity, a data exchange with the car A/V 4 via an existing wireless communication means (such as Blue-tooth) is enabled. Next the power on the portable phone (S34) is turned on. Then the engine (S35) is started and the acquisition setup data (S36) is confirmed. The confirmation of the acquisition setup data is used to confirm the acquisition data required for a diagnosis displayed on a liquid crystal display (LCD) monitor on the car A/V 4, as the displayed in the example shown in the lower part of FIG. 7. The display on the LCD monitor is also configured to enable confirmation of setup content such as a sensor position in the vehicle, a time interval of acquiring data, the existence of a built-in digital camera function on the portable phone 3 when in a standby state, et cetera. Next transmission and reception of data to and from the portable phone 3 (S37) is validated, followed by confirmation of whether an already set-up acquisition data, which is required for a diagnosis, is to be retained (S38). If the setup is to be changed, the process returns to step S36 for entering a change procedure. The LCD monitor display screen is also used for a setup operation panel to enable a change of acquisition data by selecting a prescribed position to be changed in the operation panel. If the set-up is not changed, the data after the vehicle starts running is automatically stored in the storage medium on the portable phone 3 (S39). The configuration is such that the built-in camera photographs a car window picture coinciding with the acquisition of the in-vehicle sensor data. The data and picture are combined with the latitude and longitude data acquired from the navigation system, thereby making it possible to grasp a run environment accurately at the time of data is acquired. When the customer user stops the engine and leaves the automobile 2 (S40), the user takes the portable phone 3 out of the placement holder to carry with her/him (S41). This illustrates the processes when driving an automobile.

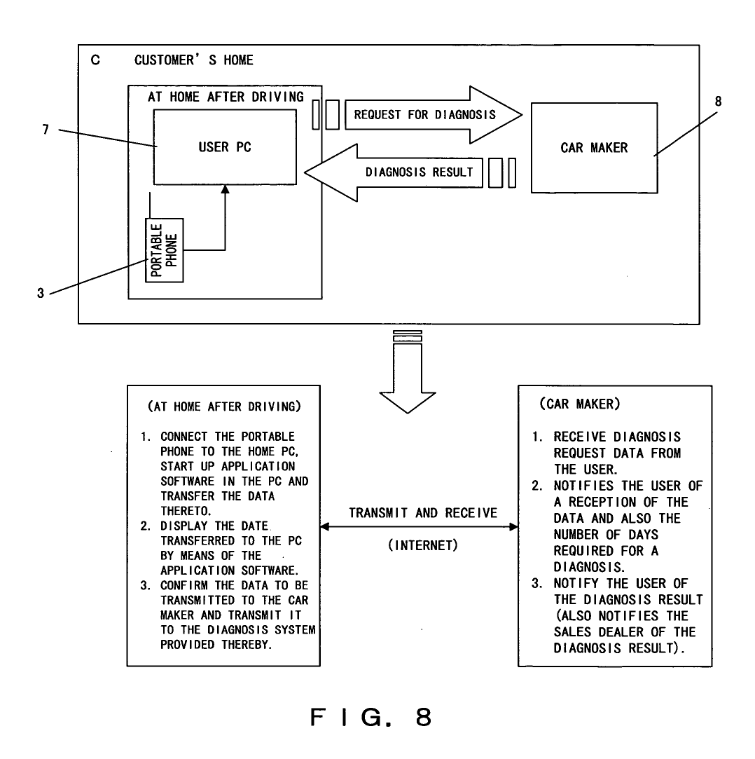

FIG. 8 is a diagram that shows the action of taking a diagnosis system, provided by the automobile manufacturer, from a user's home PC as shown by block C of FIG. 3. The user connects a portable phone 3 to a home PC by way of an interface cable such as a USB. Having started up the home PC, the user inputs the ID and (initial) password to access the service provision system provided on to the car maker's 8 Web page, wherein a diagnosis service can be obtained. If the application software for transferring data stored on a portable phone 3 to a home PC 7 has not been installed, the user downloads the software from the Web page of the service provision system. Opening the application software on a PC, the user transfers the desired data from a portable phone 3 to a PC 7 in accordance with the instructions on the Web page and displays the data therein. The user validates the data to be transmitted to the car maker 8 and presses a transmit button to transmit the data (i.e., diagnosis data). Having received the data (i.e., diagnosis data), the car maker 8 confirms the data and transmits the number of days required for issuing a diagnosis result to the user. Having acquired a diagnosis result, the car maker 8 transmits it to the user who notifies the car maker 8 that it has been received. If the user has already notified the car maker 8 of her/his electronic mail (e-mail) address, the car maker 8 may transmit the diagnosis result simultaneously by e-mail. Sending the diagnosis result to the sales dealer makes a dealer support easier.

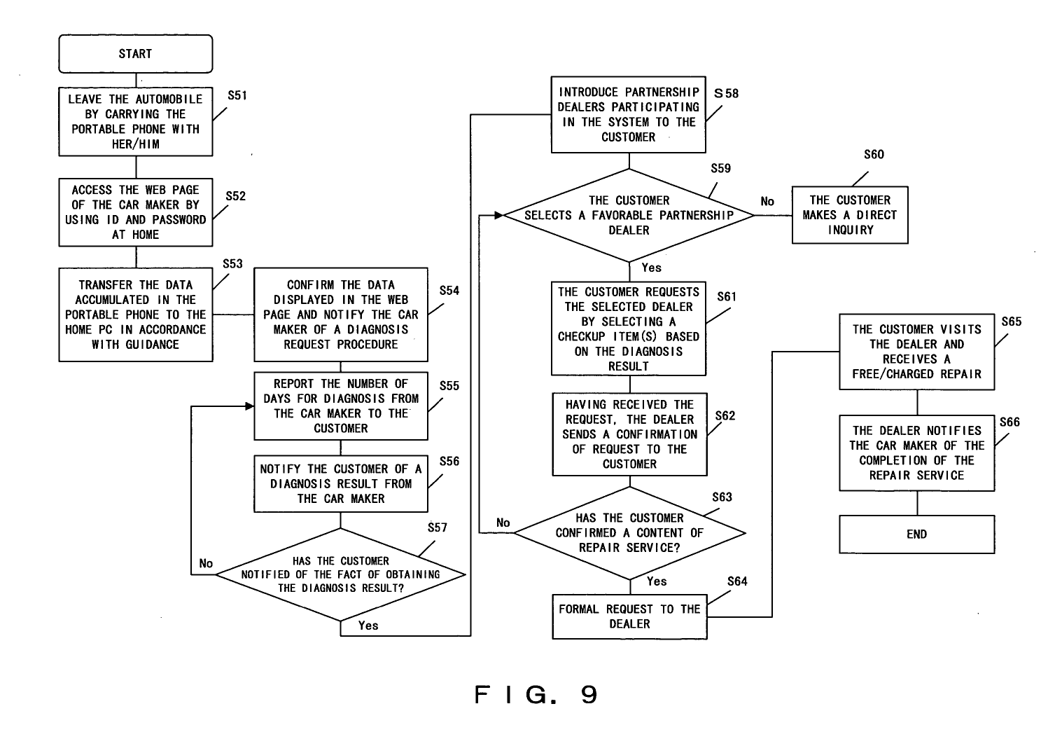

FIG. 9 is a flow chart diagram of an operation for requesting for a diagnosis service at a home PC as shown in FIG. 8. First, the user leaves the automobile and takes the portable phone 3 with her/him (S51). The user connects the portable phone 3 to a PC by way of a USB interface cable, or other cable. The user turns on the power to the PC 7 and accesses the contracted car maker's 8 Web page, which provides a diagnosis service by inputting the ID and (initial) password (S52). Next, desired data from among the data stored on the portable phone 3 is transferred in accordance with guidance from the Web page (S53). The user is required to pay attention so that unnecessary data is not displayed, e.g., data pertaining to privacy such as latitude, longitude, and car window pictures. Having confirmed data to be transmitted, the user clicks a confirmation button and then a transmit button to notify the car maker 8 of the diagnosis request procedure (S54). On the other end, having received the diagnosis data transmitted from the user, the car maker 8 notifies the user that the diagnosis data has been received and the number of days required for issuing a diagnosis result (S55). Having acquired the diagnosis result, the car maker 8 notifies the user of the diagnosis result (S56). If the car maker 8 sends the diagnosis result to the sales dealer, or the sales dealer's head office, the dealer can be organize a service support system prior to a user's visit. The user notifies the car maker 8 that a diagnosis result (S57) has been obtained. The car maker also introduces a dealer(s) that have participated in the system (S58) (hereinafter named as “participating dealer”) on the Web page. The user selects a nearby and convenient participating dealer (S59). The reason for allowing the user to select a convenient participating dealer because there may be cases where having the user visit the sales dealer is inconvenient because of a move by the user in several years after contracting with the sales dealer. Thus the system is built in consideration of the user. It is of course possible for the user to make an inquiry to the car maker 8 if the user does not select the participating dealer at her/his discretion (S60). Then, the user adds her/his own request (e.g., a checkup item, a visit date, or such) and sends the diagnosis result to the selected dealer (S61). Having received it, the dealer confirms the user's request (S62). The confirmation may be sent by way of a Web page or e-mail. Having confirmed the content of the service and the readiness of the dealer, the user notifies the dealer of the confirmation (S63) and makes a formal request to the selected dealer (S64). The user later visits the dealer later on and receives a free service or charged service such as checkup and/or repair (S65). Having completed the checkup and/or repair of the user's automobile, the dealer reports the contents of the completed checkup and/or repair carried out on the automobile to the car maker 8 (S66). This report is stored on a service system database provided by the car maker 8, and is utilized to develop new vehicles and equipment. This is illustrative of the operations used when requesting a diagnosis service by using a PC.

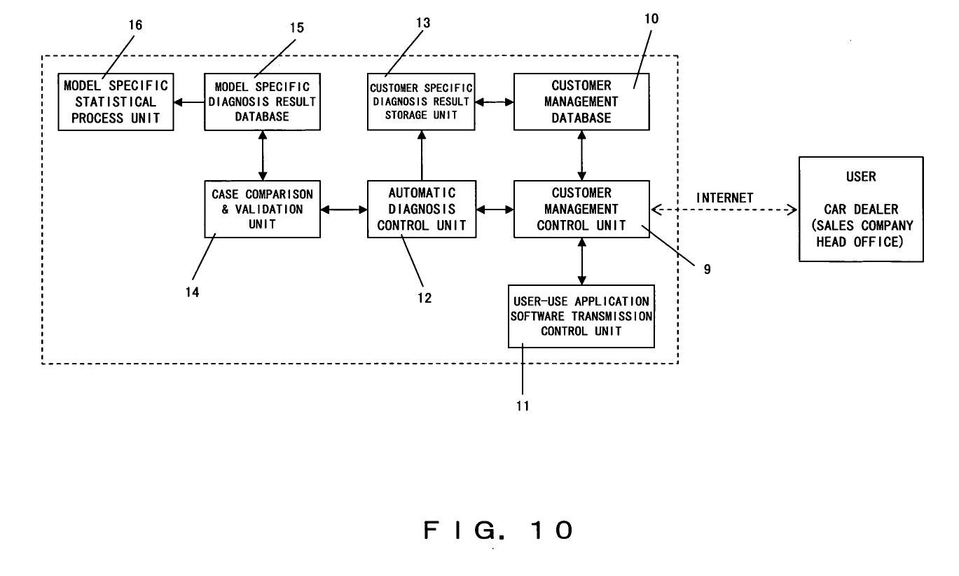

FIG. 10 is a diagram showing a configuration of an automobile manufacturer diagnosis system according to a preferred embodiment of the present invention. With regard to the diagnosis data transmitted from the user via the Internet, a customer management control unit 9 searches in a customer management database 10 to confirm whether or not the user has been registered, and registers the user's latest access situation in the customer management database 10. If the contracted user requests application software to be downloaded, a user-use application software transmission control unit 11 issues permission to download. Next, the diagnosis data transmitted by the user is inputted into an automatic diagnosis control unit 12, which diagnoses and analyzes it. The automatic diagnosis control unit 12 is enabled to automatically grasp an altitude while running based on position data (i.e., latitude and longitude) that the user has transmitted by using a map database (not shown herein). The map database is comprised of an automatic diagnosis control unit 12, thereby making it possible to estimate an atmospheric pressure, et cetera. A diagnosis result output from the automatic diagnosis control unit 12 is stored in a customer specific diagnosis result storage unit 13 for each user. The diagnosis result is subjected to validity verification while a case comparison & validation unit 14 compares with historically accumulated cases, by using an automatic diagnosis control unit 12, with cases of the applicable model stored in a model specific diagnosis result database 15. A model specific statistical process unit 16 analyzes variations in the diagnosis results based on the model specific diagnosis result database 15. The car maker 8 is advantaged by having the capability of improving a specific model and/or making good use of the diagnosis data to develop new vehicles and equipment based on the accumulated data in company's diagnosis system database. Upon completing a validity verification of the diagnosis result, the car maker 8 adds a brief comment to the diagnosis and checkup item for each unit (e.g., an engine unit, a power transmission unit, a suspension system, a braking system, et cetera), automatically searches the sentence examples retained by the model specific diagnosis result database 15 for specific measure(s) for a future action, adds it (or them) to the diagnosis result form, and reports the resultant to the user and sales dealer (or affiliated dealer) via the Internet coinciding with a notification schedule for the diagnosis result. Note that the configuration is such that user diagnosis data can be stored on a user's PC 7 hard disk by means of the application software that the contracted user downloaded to receive diagnosis result notification and provisions of other services (e.g., a retrospect scene creation service which is described later). However, the customer can open the customer PC's 7 Web page only when accessing the car maker's 8 Web page by inputting the ID and password.

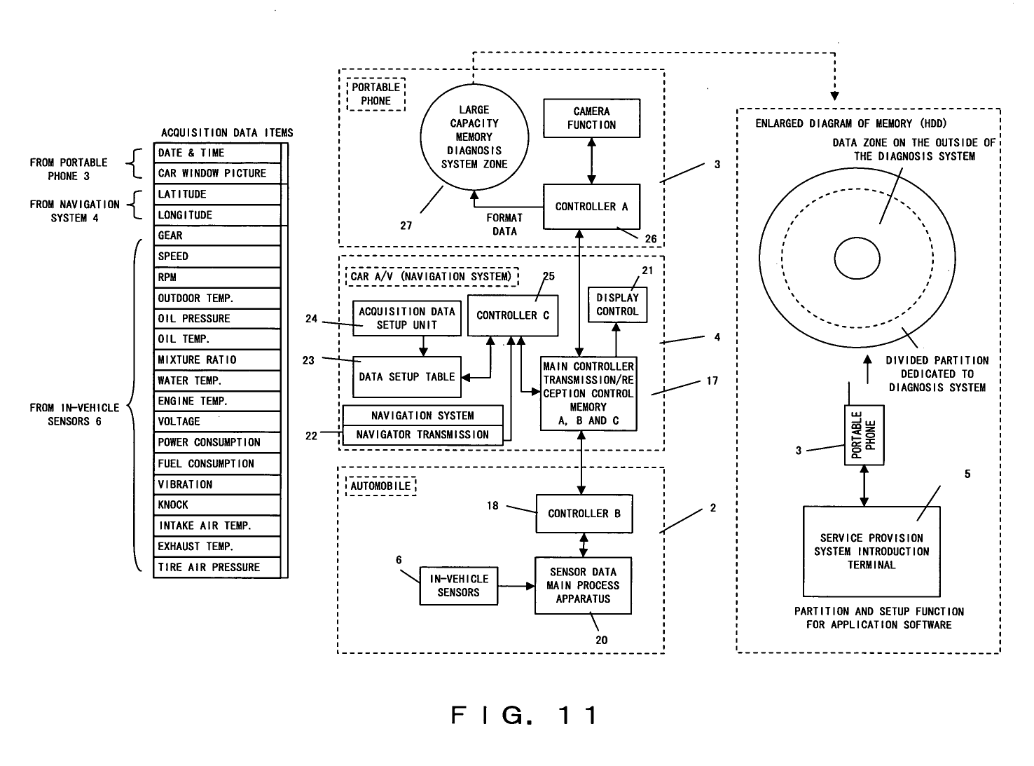

FIG. 11 is a block diagram showing acquired data being processed from a portable phone, a car A/V (including a car navigation system), and an automobile, while the automobile is traveling, which is in according with a preferred embodiment of the present invention. A main controller 17 of the car A/V 4 (including a car navigation system) controls the transmission and reception of data between the automobile 2, the controls, and the portable phone 3. The present embodiment is configured in a manner that the car A/V 4 (including a car navigation system) comprises the main controller 17; however, in an alternate configuration, the automobile 2 may comprises the main controller 17.

It is configured such that a sensor data main process apparatus 20 performs analog/digital-(A/D) conversion which converts various sensor data acquired from the in-vehicle sensors 6 equipped in the automobile 2, control an array of the various sensor data, and add an identification code (not shown in a drawing herein), such as a sensor identifier, to each element of the data array. It is also configured to add of the time for acquiring data to at least the head or tail end of the data array at a set time interval, via a controller A26 or C25 and main controller 17, by using a clock function comprised by car A/V 4 (including a car navigation system) or portable phone 3. The resultant is then stored in a memory unit (not shown in a drawing herein) of a sensor data main process apparatus 20 by a function of controller B18. Then, the controller B18 calls up the data array to which the acquisition time and the sensor identifier are added, which has been stored in the memory unit (not shown in a drawing herein) of the sensor data main process apparatus 20 and the data array (to which the sensor identifier is added in accordance with a transmission control signal transmitted from the main controller 17), transmits it to the main controller 17, and stores it in a first memory unit A (not shown in a drawing herein) within the main controller 17. Data acquisition conditions, such as a car navigator set-up, in-vehicle sensor setup, car window picture setup and data acquisition time interval setup, are set in the acquisition data setup unit 24 of car A/V 4 (including a car navigation system). Incidentally shown on the left side of FIG. 11 is a list of acquisition data items with respective corresponding data acquisition sources. The conditions set by the acquisition data setup unit 24 are stored in nonvolatile memory (not shown in a drawing herein) in a data setup table 23 and are automatically called up by the main controller 17 when the engine is started. A navigator transmission unit 22 controls the navigator data array, adds an identifier (not shown in a drawing herein) for each piece of data to each element in the data array, further adds the time the data was acquired at a setup time interval to at least the head or tail end of the data array via a necessary controller by using the clock function comprised by car A/V 4 (including a car navigation system) or portable phone 3 by a function of the controller C25, and stores the resultant in a memory unit (not shown in a drawing herein) of the navigator transmission unit 22. Then, the controller C25 calls up the data array to which the acquisition time and identifier are added, which has been stored in the memory unit (not shown in a drawing herein) of the navigator transmission unit 22, and then it is transmitted to the main controller 17 and stored one time in a second memory B (not shown in a drawing herein) within the main controller 17; all in accordance with a transmission control signal of the main controller 17. Meanwhile, in the portable phone 3, the controller A26 controls and adds a photographing time identifier (not shown in a drawing herein) of the car window picture data sequentially photographed to link with the clock function comprised by car A/V 4 (including a car navigation system) or portable phone 3. The resultant then transmitted to the main controller 17 and stored one time in a third memory C (not shown in a drawing herein) within the main controller 17; all in accordance with the data setup table 23.

The in-vehicle sensor data stored in the memory A, the navigation data stored in the second memory B, and the car window picture data stored in the third memory C, of the main controller 17, are converted into a data block for each mutually coincident time identifier. The converted data block is transmitted to the controller A26 of a portable phone 3 via the operation of the main controller 17. The transmitted data block is converted in accordance with a format of the application software controlling a display and the data array, the software being pre-stored in a large capacity storage unit 27, via the operation of the controller A26 so as to be compatible with the operation of the home PC of the user. The transmitted data block is sequentially stored in the large capacity storage unit 27 retained by the portable phone 3. The large capacity storage unit 27 uses a compact hard disk (HDD), nonvolatile semiconductor memory, or other memory apparatus.

In the present embodiment, after the user signs up for a service provision contract, including diagnosis, the storage unit 27 is equipped in a portable phone and is configured to make a diagnosis-use root directory when application software is installed in the portable phone 3. This makes it possible to automatically refer to the diagnosis-use directory and makes only use of diagnosis-use accumulated data on the user's PC when accessing the car maker's Web page that contains storage unit 27 data equipped in the portable phone 3. When the user makes use of diagnosis-use accumulated data of the portable phone 3 on a home PC and stores the diagnosis-use accumulated data on a PC storage apparatus—or another storage apparatus (not shown in a drawing herein),—an additional mechanism automatically erasing the accumulated data, or the directory, from a storage unit 27 is equipped on a portable phone 3. This makes it possible to secure a storage zone the diagnosis-use data that is constantly on a storage unit 27 of the portable phone 3, and makes it possible to acquire diagnosis-use data securely. As shown in the enlarged diagram on the right side of FIG. 11, to secure the diagnosis-use data zone, certain zones of a storage unit 27 are divided and equipped on a portable phone 3 using a different partition than the storage data zone. Typically, setting a specific zone for a diagnosis system makes it possible to always secure a certain diagnosis-use data zone when using the portable phone. In this case, it is only possible to access to a divided partition on the storage unit 27 for the car maker's Web page. The application software of the service provision system (including diagnosis) is accommodated in the partition, thus enabling the installation of an operating system (OS) that is dedicated to the service provision system—including diagnosis. When a user signs up for the present contract, the setup zone is carried out by the service provision system introduction terminal 5, which connects a portable phone 3 by way of a cable interface such as a USB or RS232C. Note that it is preferable to set the divided partition on the outer circumference part of a hard disk (HDD) in terms of a transfer rate. Meanwhile, if a partition has not been set in a large capacity storage unit 27 of the user's portable phone 3, the service provision system introduction terminal 5 functionally makes the data stored on the user's portable phone 3 storage unit 27 take shelter in the storage unit (not shown in a drawing herein) of the service provision system introduction terminal 5, then sets a partition, installs application software, and rearranges user data (that has been stored on a storage zone on the outside of a set partition. The user data, which has taken shelter on the storage unit (not shown in a drawing herein) of the service provision system introduction terminal 5, is automatically erased from the storage unit (not shown in a drawing herein) when the above described setup process is finished.

As described above, a diagnosis request is made from the portable information equipment, to the home or office PC, to the car maker's Web page that puts together data on time and/or travel distance. Therefore, the car maker is not required to process it in real time, thereby providing a beneficial secure service with an extremely low likelihood of telecommunication failure. Furthermore, since there is no need to transmit a diagnosis result in real time to a user on the move, there is no telecommunication fee required for the car maker's normal service. In the present embodiment, if each of 400 thousand contracted cars requests diagnosis a month, the car maker is required to build a system capable of dealing with ten requests per minute. While it is also possible to access the car maker's Web page, download a diagnosis program, and have the user do a diagnoses; it can be configured to also have the diagnosis result sent back to the car maker so that the car maker can benefit by accumulating a database. If a diagnosis program is provided for each vehicle model, an update is only required for minor or full model changes in the model.

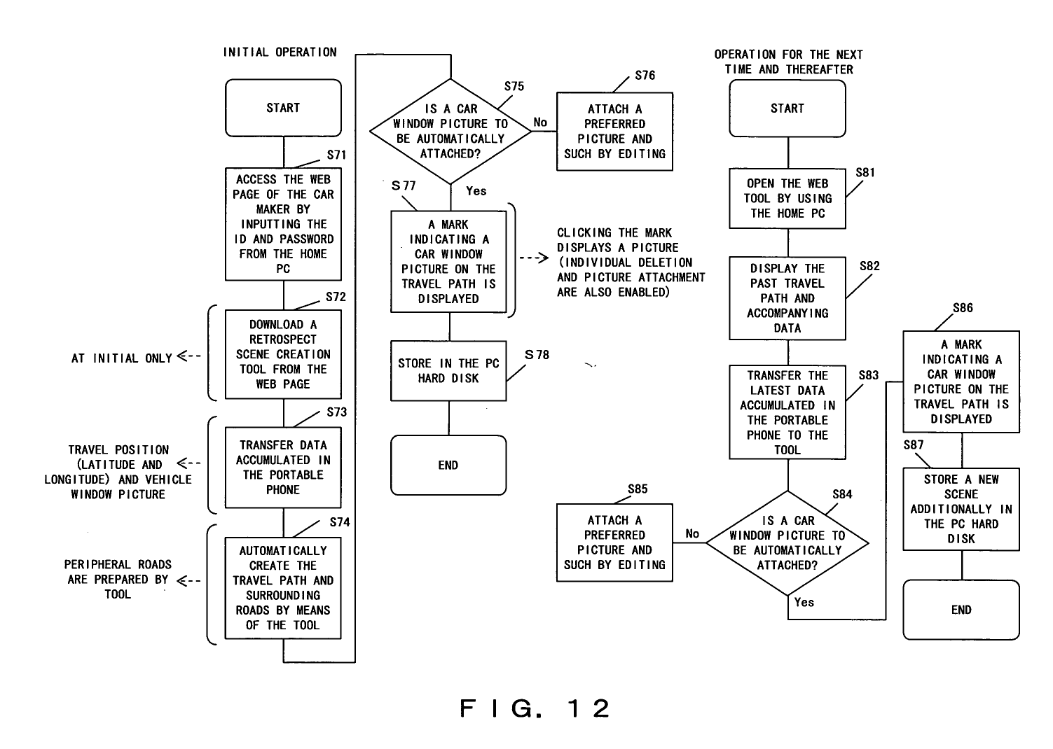

FIG. 12 is a flow chart diagram describing a retrospect scene (e.g., an album) creation service as an example of a service provision, other than a diagnosis service, according to a preferred embodiment of the present invention. This service enables the user to utilize the data accumulated on the portable phone 3 to make a retrospect scene (e.g., an album) on a home PC. The user accesses the car maker's Web page by inputting the ID and password (S71). The user downloads a retrospect scene creation tool from the Web page (S72). This download is carried out during the customer's initial operation. The user transfers travel path data (i.e., latitude and longitude) and the car window picture photographs, that are accumulated during the travel, from a portable phone 3 to the PC (S73), which operates with the Web page's guidance tool and automatically creates the travel path and surrounding roads (S74) (note that the surrounding roads are prepared by the tool.) Then, the user judges whether the car window picture should be automatically attached to the created travel path and surrounding roads (S75). If an automatic attachment is not carried out, the user may edit (S76) the pictures by attaching a preferred picture photographed by a digital camera or a preferred car window picture. If an automatic attachment is performed, a mark (refer to the lower right corner of FIG. 5) is displayed to indicate a car window picture on the travel path (S77). Clicking the mark makes it possible to display a car window picture or attach another picture by deleting each car window pictures individually. This creates a retrospect scene (e.g., an album) that can be used to remember a car trip (at a travel destination) and the travel path. The created retrospect scene data is stored on the hard disk of the PC and ends the process (S78). As a result, the user can enjoy a retrospect scene (i.e., an album) integrating the memories of the car trip (at a travel destination) and the travel path. Note that the tool is configured to be functioned on the Web page only when accessing a Web page, and that the car maker's Web page needs to be open for making use of the stored data on the PC.

When utilizing the retrospect scene creation service on subsequent occasions, the user opens the Web page using a home PC (S81), and making use of the data stored on the hard disk of the PC (i.e., the past travel path and accompanying data in the Web page (S82).) Then the user transfers the latest data accumulated on the portable phone to the tool (S83), and then judges whether or not to carry out an automatic attachment of a car window picture to the travel path and surrounding roads (S84). If the automatic attachment is not carried out, the user may edit (S85) the picture by attaching a favorite picture photographed by a digital camera, or a favorite car window picture. If the automatic attachment is carried out, a mark (refer to the bottom rightmost part of FIG. 5) indicating a car window picture is displayed in the travel path (S86). The new retrospect scene (i.e., an album) integrates the memories of the car trip (to the travel destinations) with the travel path. Thus, a new retrospect scene data is create and stored in the hard disk of the PC, which ends the process (S87). As a result, the user may enjoy the new retrospect scene (i.e., an album) by integrating the memories of the car trip (to the travel destinations) and the travel path.

Next is a description of examples of service provisions, other than the above described retrospect scene creation service. The present service (although it is not shown in a drawing) is configured to enable the user to access to the car maker's Web page from a home PC after accumulating local information (i.e., sightseeing information in a local area and advertisement information) on a storage medium of a portable information equipment via a car A/V, and refer to the local information stored in the storage medium of the portable information equipment in the Web page (hereinafter “local information browse service”). That is, it is configured to store local information provided by the Web along with diagnosis data on the storage medium of the portable information equipment used for the service provision system, including diagnosis. It is further configured to permit a user to access to the car maker's Web page from a home PC after the user comes home, thereby enabling the user to refer to the local information stored in the storage medium of the portable information equipment. Specifically, it is configured to accumulate the diagnosis information obtained by way of the car A/V 4 during a car trip and also the local information on the user's portable phone 3, and then, after leaving the car, access the car maker's Web page from a home PC 7, and refer to the local information accumulated by the portable phone 3 on the Web page. This configuration enables a thorough access to the local information obtained during the car trip (in the travel destinations) or on a commuting route. Although there has conventionally been a service for obtaining local information (such as advertisement on the Web) via a car navigation system, the configuration has not enabled the user to thoroughly look, hear or utilize the local information provided while driving a car. Contrarily, in according with the present invention, the local information browse service is configured to make it possible to store the local information obtained during the car trip in a storage medium of a portable information equipment, access to the car maker's Web page from the user's home PC; after the user comes home and refer to the local information stored in the storage medium of a portable information equipment, thereby enabling the user to thoroughly look, hear, or utilize the local information while driving a car. This service, coupled with a diagnosis service available for the user, provides the ca maker 8 with an invaluable vehicle running data for the car maker 8.

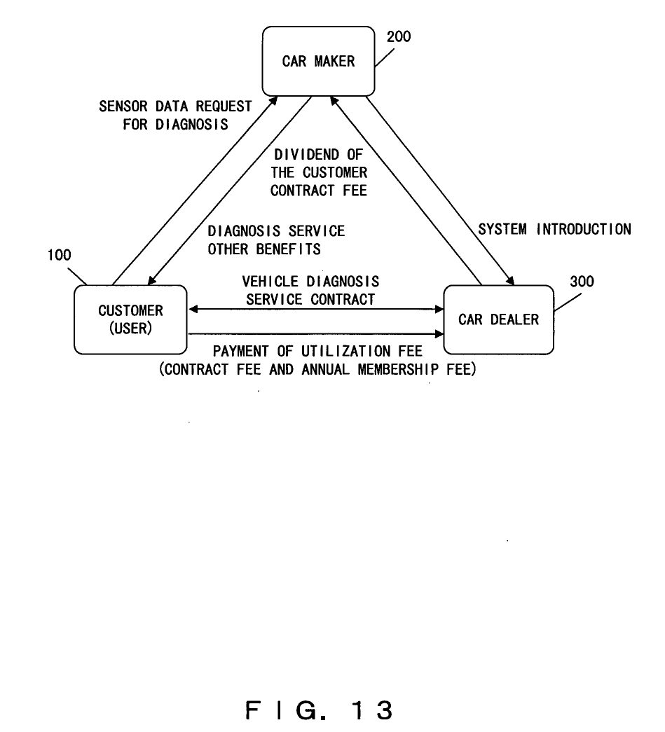

FIG. 13 is a diagram showing a first business model, according to a preferred embodiment of the present invention, which is generated when the service provision entity is an automobile manufacturer. As described in FIGS. 3 through 10, a car maker 200 carries out a contract procedure with a customer 100 (i.e., a user) at a car dealership 300, in order for a user 100 to sign up for a service provision contract, including a vehicle diagnosis. The user 100 need pay a utilization fee (a contract expense and an annual utilization fee) by a credit card or other method of payment. The car maker 200 furnishes the car dealer 300 with equipment and software required to utilize the system and pays a part of the utilization fee that was collected from the user 100 as a contribution fee in accordance with the contribution of the car dealer 300. An indicator for the contribution fee may include the income from the service contract, the improvement of the development efficiency, or the monetary benefit to the car maker 200 derived from the utilization of the build-up collection of diagnosis data. These items can be expressed numerically for an accounting by the car maker 200; therefore, they would probably constitute a high accuracy indicator. A non-monetary benefit may include gauging customer satisfaction by collecting questionnaires from customers 100 and making improvements from them. An expected monetary benefit to the car dealer 300 includes dividend from the income of the contract and an increased income on repair and replacement parts resulting from the increased number of users requesting repairs. A non-monetary benefit includes an increase in direct contact with the user 100, which improves user 100 confidences.

Benefits for the user 100 include monetary benefits such as preventing major repairs and non-monetary benefits such as a user's sense of security that the vehicle can always be driven securely and the user's own recognition of the importance of prevention. An online-system diagnosis service has conventionally been proposed; however, a real time service for a user has a high risk of excessive telecommunication cost from a portable phone, in addition to the contract fee and annual membership fee. Therefore, there is a risk of increased cancellations due to the increased payment required by the user. Meanwhile, the issuance of a diagnosis failure during a run increases a user's sense of insecurity. Furthermore, if a message indicating that the defect has lessened is repeated, then after a certain length of time, there is a risk of the user not trusting the real time diagnosis service. Contrarily, according to the present invention, the diagnosis provision service is capable of not only eliminating a user's sense of insecurity in advance, but also providing a fundamental diagnosis service for enabling the user to concentrate on the drive. The diagnosis provision service is further capable of building up a substantial amount of data to use in a database that allows the car maker to make developments and improvements on behalf of the car maker, thereby making it possible to continue a high quality diagnosis service.

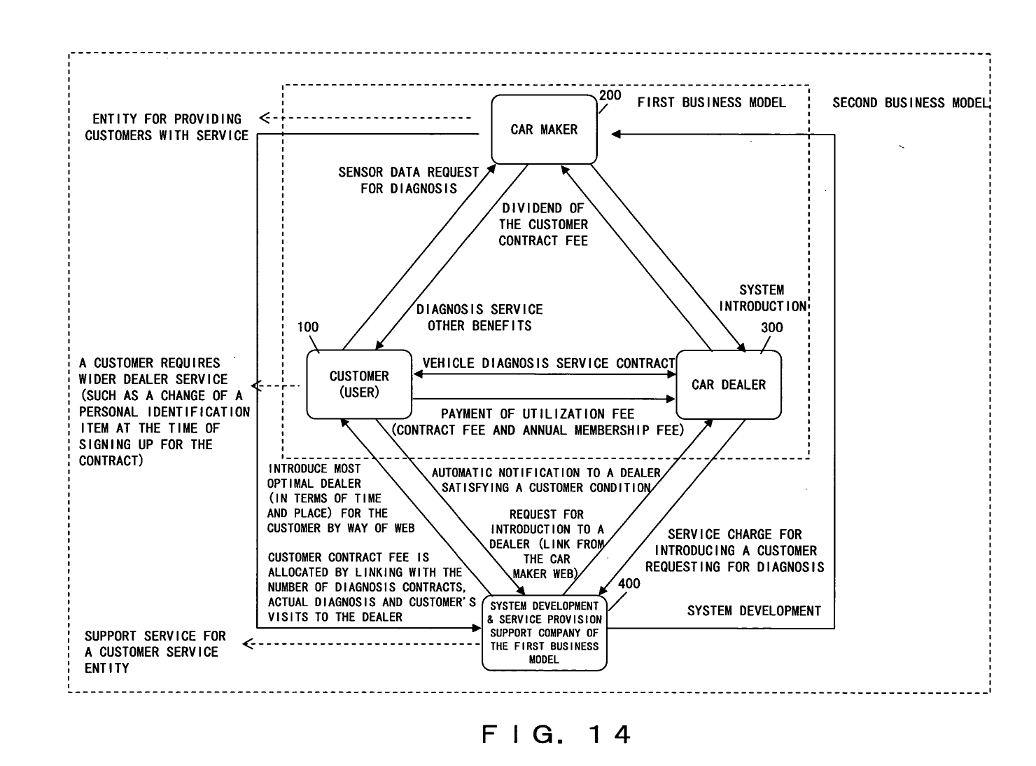

FIG. 14 is a diagram according to a preferred embodiment of the present invention that shows a second business model in which a service provision support company is separately established to comprehend the first business model shown in FIG. 13 and further develops thereof. Referring to FIG. 14, a service provision support company 400 develops a system related to the present business model for a car maker 200, and receives an allocation of a user's contract fee for linking numerous diagnosis service contracts, a number of actual diagnosis, and dealer visits by the users 100. The service provision support company 400 carries out an installation, maintenance/management, updates the system related to the present business model for the car dealer 300, and also interfaces between the user's 100 and car dealer's 300. An example of interfacing between the user's 100 and car dealer's 300 include periodic updates of the car dealer's 300 service provision content that is related to the management of the car maker's 200 Web page. On the Web page, the user 100 may search for the most optimal dealer (in terms of time and geography) for the present contract, or request to be introduced to a dealer by linking to the car maker's 200 Web page and also automatically notifying a dealer that satisfies the condition; thereby the request and complaint are processed with regard to the system related to the present business model. Even such a service provision makes it possible to reduce the management load on the car maker 200 without damaging the car maker's 200 security. The second business model exposes the service provision support company 400 that would otherwise be fundamentally invisible in the first business model's domain. The service provision support company 400 collects a contribution fee from a car maker 200 based on an indicator, such as a growth in the contract amount and/or number of customers 100, or an improved efficiency of development and improvement by the car maker 200, or an improved profit by the car dealer 300.

Benefits of the second business model shown in FIG. 14 include a monetary benefit for the service provision support company (400) that appears in the present business model, an ability to collect a contribution fee based on the amount paid by users in a service contract, and a number of contracted dealers and users may be introduced to each other. Non-monetary benefit for the company (400) include the ability to plan to improve efficiency in system development, maintenance/management, and update present business models by measuring the degree of satisfaction from the car maker, car dealer, and/or user. Note that the monetary benefit and non-monetary benefit to the user, car dealer, and car maker are similar to those of the first business model shown in FIG. 13; therefore, a description is omitted here.

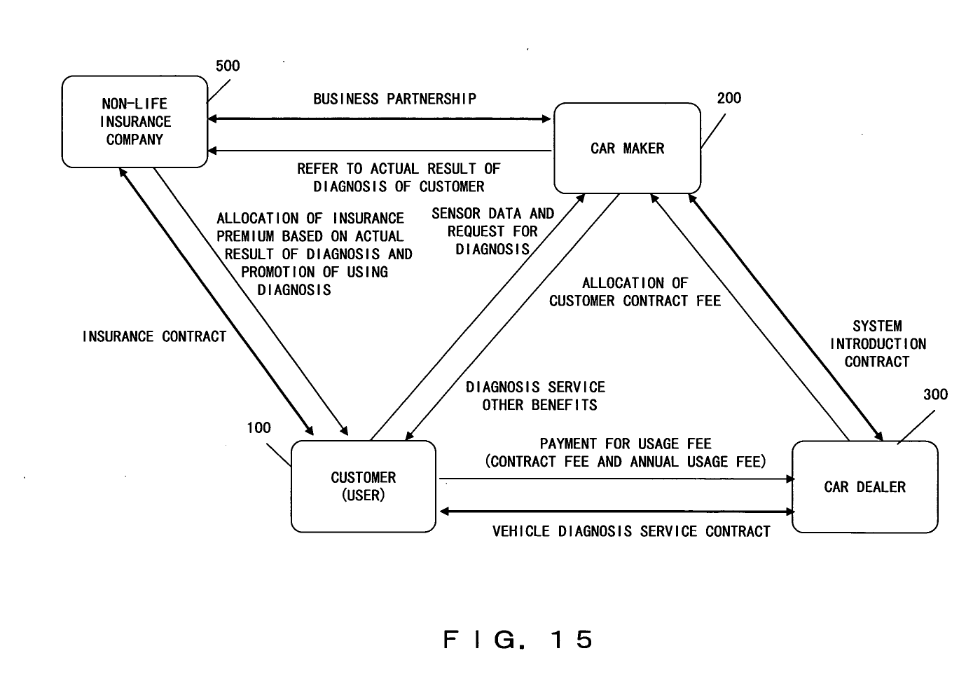

FIG. 15 is a diagram, according to a preferred embodiment of the present invention, for describing a third business model in an attempt to cooperate with non-life insurance companies. The car maker 200 forms a partnership with a non-life insurance company 500, which provides total benefits of the service provision system including diagnosis. The user 100 selects a partnered non-life insurance company 500 on car maker's 200 Web page and enters into a procedure for buying new insurance. The non-life insurance company 500 notifies the car maker 200 of the establishment of the new insurance contract based on the application content of the contract with a user 100, thereby the non-life insurance company 500 becomes entitled to obtain information relating to an actual diagnosis of the user 100 from the car maker 200 at any time. Associated with the establishment of the user's 100 new insurance contract, the non-life insurance company 500 notifies the car maker 200 of the user's 100 code number and the insurance subscriber/user's management number that is then stored as a collateral condition of the user 100 in a customer management database 10 retained by the car maker's 200 diagnosis system shown in FIG. 10. A special code allowing the car maker 200 to access only a contract user's actual diagnosis results is assigned to the non-life insurance company 500 by the car maker 200 so as to enable the non-life insurance company 500 to monitor the insurance subscriber's actual diagnosis results automatically by accessing the car maker's 200 system by using the non-life insurance company's system (not shown in a drawing herein). Here, the actual result of the diagnosis, which is included in the customer management database 10, is defined as the user's 100 diagnosis request and the actual result of the security actions that are related to maintenance including repair and other factors that the car dealer 300 based the result of the diagnosis on. The non-life insurance company 500 obtains a mechanism to determine the amount of insurance premiums to be distributed to the user 100 at the close of an insurance subscription. These are determined by using the actual results of the diagnosis as an indicator, so that a link to the non-life insurance company's 500 system (not shown herein), makes it possible to automatically deposit an insurance premium allocation into the account of a user 100 at the close of an insurance subscription or start of a new contract. Meanwhile, the non-life insurance company 500 can make contact with a user 100 who has a low actual diagnosis result to better distribute insurance premiums. Therefore, the non-life insurance company 500 is enabled to advise the user 100 from an earnest point of view and bring forth a favorable business system cycle, as compared to a case of the car maker 200 prompting a request for diagnosis to a user 100 who has low actual diagnosis results.

The present business model is expected to be a service for improving the ratio of contracts for the non-life insurance company 500 and also as one for suppressing a total insurance payment. Building up such a business model enables the user 100 to proactively request diagnosis from the car maker 200, enables the car maker 200 to build up a database related to more abundant vehicle running conditions, and enables the non-life insurance company 500 to avoid the problem with insurance users subscribing because the non-life insurance company 500 can possess a fair indicator for distributing insurance premiums as a result of obtaining an actual formal diagnosis results from the car maker 200 instead of self-declarations from the user 100. These cycles bring about a favorable business cycle that has the possible social effect of decreasing the number of accidents due to poor maintenance. Furthermore, improvements in the ratio of accidents due to poor maintenance and vehicle defects enables the non-life insurance company 500 to obtain actual user diagnosis results directly from a car maker 200 so that the non-life insurance company 500 ca allocate discount rates to each user 100, which enables her/him to be compensated for the present service provision system's membership fee when the user 100—who has subscribed to the service provision system including diagnosis—buys car insurance.

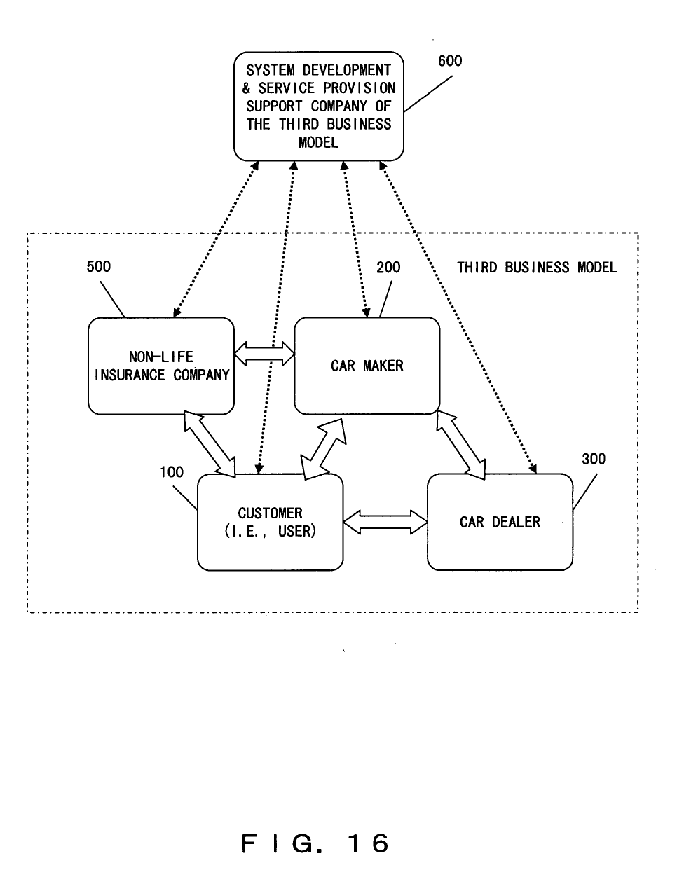

FIG. 16 is a diagram, according to a preferred embodiment of the present invention, that shows a fourth business model in which a service provision support company is separately established to comprehend the third business model shown in FIG. 15, and further develop that business model. Referring to FIG. 16, a service provision support company 600 develops a system related to the present business model for the non-life insurance companies 500 and car makers 200. It also receives allocations based on insurance contract fees from the non-life insurance companies 500, allocations from user contract fees that are linked to a number of diagnosis service contracts, actual diagnosis results, and visits between user's 100 and dealers. The service provision support company 600 carries out installation, maintenance/management, and updates the system related to the car dealer's 300 present business model and the interfaces between the user 100 and car dealer 300. The content of the interfacer is similar to the case described in FIG. 14; therefore, a description is omitted here.

As described above, a user of the present service contract subscribes to car insurance from a non-life insurance company on the car maker's Web page or a service provision entity's Web page so that the non-life insurance company, while confirming the user's actual diagnosis results, promotes utilization of the user diagnosis system and allocates an insurance premium to the contract user based on the utilization of the diagnosis system. This thereby reduces the load on the user and, moreover, enables an effective buildup of the car maker's database. It is also possible to reduce the user's annual membership fee on the present service contract to substantially zero as a result of receiving the insurance premium allocation from the non-life insurance company. Considering payments for other services, this may possibly make the service provision system appear attractive for users.

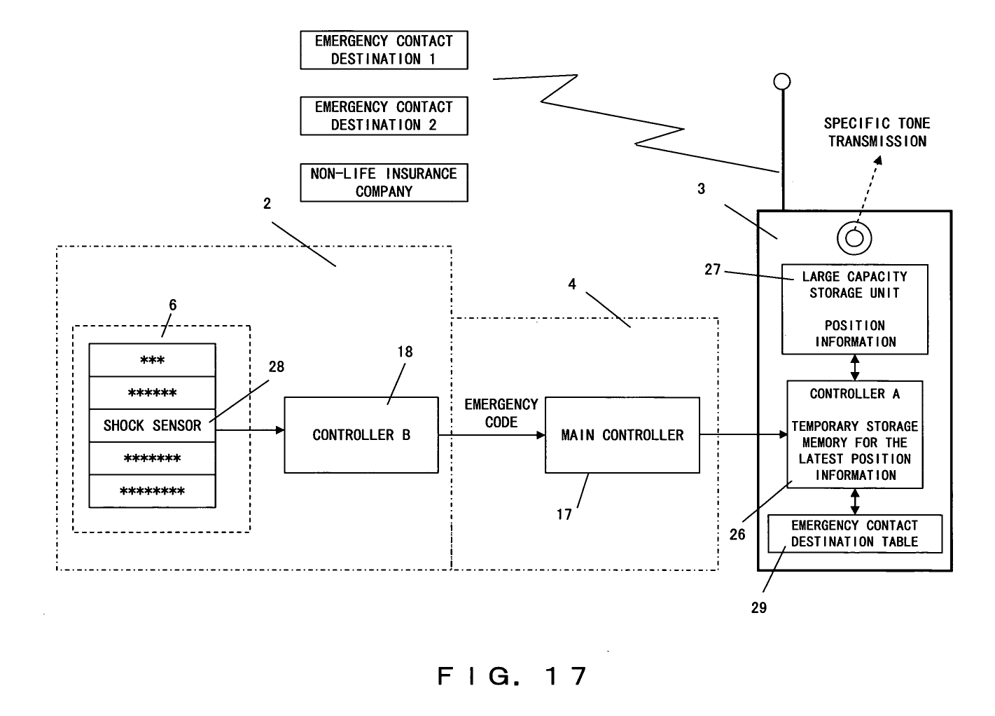

FIG. 17 is a functional block diagram, according to the present invention, related to a first embodiment for implementing an emergency communication in the service provision system. If an accident happens with only the user in the car, and if the user loses consciousness or cannot move herself/himself while conscious, a controller B18 interrupts the main controller's 17 process in the car A/V 4 and, upon detecting a level signal in excess of a certain level of an output signal of a shock sensor 28 (which is one of the in-vehicle sensors 6 equipped in the automobile 2), transmits an emergency code. Having received the emergency code, the main controller 17 instructs the portable phone 3 controller A26 to call up at least one pre-registered emergency contact phone number and/or e-mail address from an emergency contact destination table 29 and transmit an emergency message to the call destination. The navigation system of the car A/V 4 is simultaneously instructed to transmit position information by converting the latest position information (i.e., latitude and longitude)—which is stored in a large capacity storage unit 27 equipped in the portable phone 3—, into a voice and/or character. According to one embodiment, if the emergency contact destination is an individual user's personal contact, instead of a so-called emergency support center that is managed by the car maker or entity of the present service provision, it becomes unnecessary for the car maker or entity of the present service provision for personnel and equipment to respond to the emergency call. Therefore it is possible to minimize an influence on the total service cost and free the user from the payment of an annual membership fee, or the like, for such an emergency contact service.

In an emergency situation resulting from an accident, the car A/V 4 that is equipped in the automobile 2 may fail, and consequently there is a conceivable possibility that the instruction to transmit an emergency contact becomes impossible.

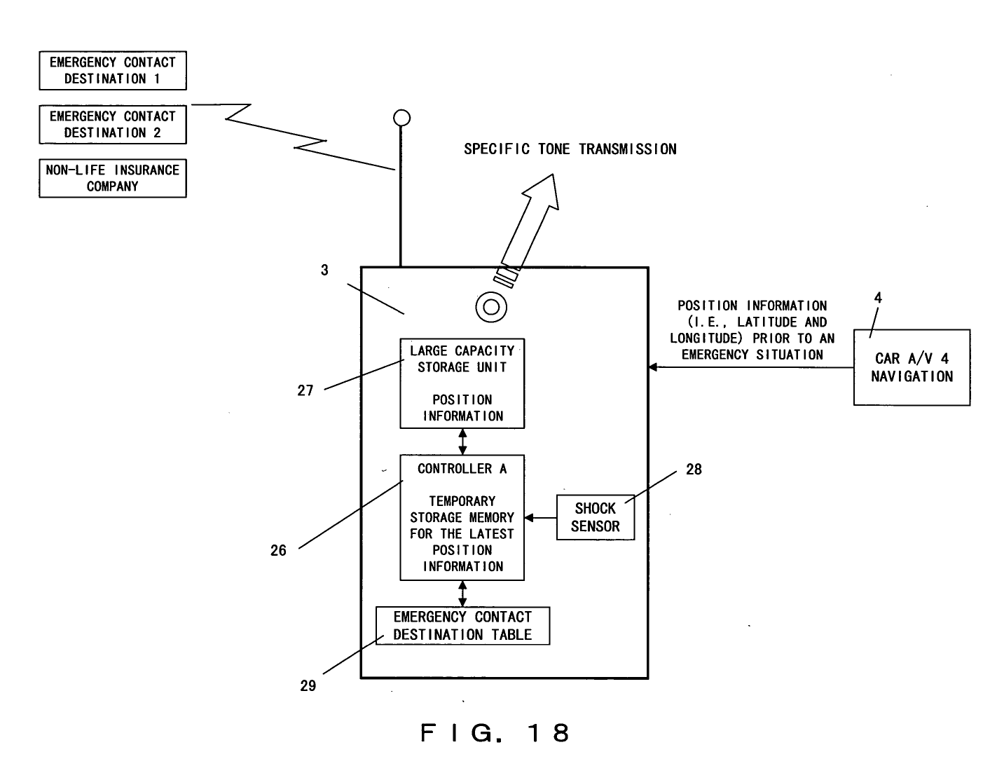

FIG. 18 is a functional block diagram, according to the present invention, related to a second embodiment for implementing an emergency communication in the service provision system. In order to respond to the case described above where the instruction for an emergency contact transmission is in the first functional block, the present embodiment is configured to incorporate a shock sensor 28 in the portable phone 3 as shown in FIG. 18. This enables the portable phone 3 to carry out an emergency contact without depending on the main controller 17 equipped in the car AV 4 (including a car navigation system). The controller A26 of the portable phone 3 detects a signal from the shock sensor 28 at a constant or at a certain time interval and issues an instruction for an emergency contact if a level signal is detected that is at or above a predetermined level.

If the large capacity storage unit 27 is a hard disk, however, there is a risk of failure if a large shock is applied. Therefore the latest position information is stored in the semiconductor memory (not shown in a drawing herein), which is equipped in a controller A26 of a portable phone 3, until the next new position information is transmitted; thereby making it possible to increase the probability of carrying out an emergency contact. The semiconductor memory preferably uses a nonvolatile memory type.

Note that the portable phone 3 is configured to automatically transmit a specific tone, or the like, to an emergency contact when carrying it out regardless of the preferred embodiment shown in FIG. 17 or 18. However, the emergency contact can be cancelled by the user herself/himself by pressing the cancel button (not shown in the drawing herein) within a preset time if the user judges that the emergency contact is not necessary.

The present service provision system comprising the emergency contact function is very useful for responding to a situation such when a user is alone and encounters an accident and/or loses consciousness. The present invention is contrived to accumulate pieces of position information obtained one after another from the car navigation system, thus making it possible to notify a call destination of the current position at an emergency contact and quickly call for a rescue. Registering a non-life insurance company as an emergency contact destination in the portable phone enables the non-life insurance company to contact family and relatives; thereby providing the benefit of a quick payment for medical bills, or other financial matters, that are carried out by the non-life insurance company.

The above descriptions of the present invention have concentrated on a common user vehicle when describing the service provision system. However, the present invention is also very useful for building up an important database and for managing the maintenance schedule if the service provision system is applied to heavy construction equipment (e.g., a bulldozer, crane, construction machine, et cetera). That is, a navigation system is not required in the case of heavy construction equipment, thus making it possible to provide a diagnosis service via a PC by transmitting diagnosis data obtained from in-vehicle sensors equipped in the heavy construction equipment to a portable phone to be stored in a storage medium. This is an extremely simple service compared to the service for a common user vehicle; yet, this is a service provision system capable of providing useful services to a heavy construction equipment manufacturers or service provision entities in terms of building up a database and managing maintenance schedule(s).

In one embodiment of the present invention, the service provision system is configured to accumulate diagnosis data in a portable information equipment and make a diagnostic decision based on a certain amount of ample data (in terms of time and driving distance). This diagnosis decision is sent to a user's PC by broadband telecommunications, thereby providing a highly accurate diagnosis system. The overall system is extremely simple and the user is totally free from paying telecommunication costs, especially when the annual membership fee is substantially lowered and the car maker can obtain a large amount of information to use in the after market. This enables equipment to be developed from the customer's point of view because the system does not use the user's portable information equipment for telecommunication with the maker, non-life insurance company, dealer, or service provision company. When the service provision system (including diagnosis of the present invention) is utilized for business, an individual's portable phone can be utilized without any telecommunications costs; thereby eliminating the need for a business entity to provides specific portable information equipment. Being free from cumbersome office work, such as settling expense accounts relating to operation cost (e.g., a telecommunication expense), makes this a convenient service provision system.

The first embodiment of the present invention is configured to accumulate sensor data while vehicle is running as well as other run environment information (i.e., position information, car window picture, and local information) and store the information in a storage unit 27 equipped on a portable phone 3. The second embodiment of the present invention is configured to accumulate sensor data while vehicle is running as well as other run environment information (i.e., position information, car window picture, and local information) from a car A/V having a built-in navigation system (i.e., an HDD navigation system) that incorporates a hard disk. The second embodiment accumulates sensor data while vehicle is running as well as other run environment information and stores it on the HDD navigation's hard disk, thereby enabling the user to drive a car without carrying a portable phone with her/him. The user is enabled to receive similar service provision as those described above in the first embodiment by importing the diagnosis data from the HDD navigation's hard disk of to the portable phone's storage unit equipped on a later day.

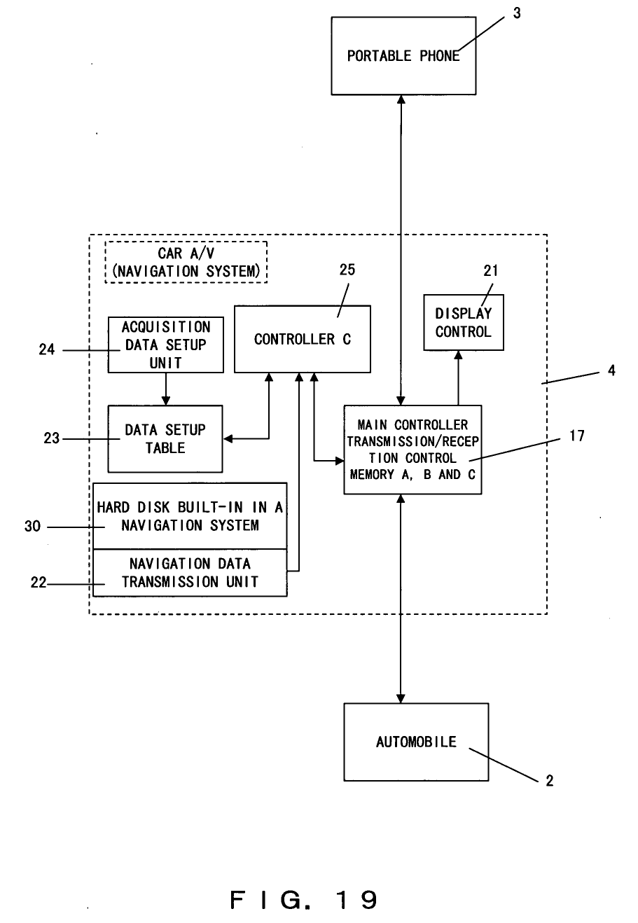

FIG. 19 is a block diagram showing a configuration for making a car A/V's navigation system's hard disk a diagnosis data storage medium in the service provision system (including diagnosis of the present invention.) In this configuration, the car A/V's 4 navigation system's hard disk 30 is capable of accumulating data with or without a portable phone 3 being placed in a prescribed position of the vehicle. As previously described in FIG. 11, the in-vehicle sensor data stored in a memory A, the navigation data stored in a second memory B and the car window picture data stored in a third memory C, of the car A/V's main controller 17 are converted into a data block for each mutually identical time identifier. (In the conceivable case of a portable phone not being present in the car, the car window picture data in memory C would not exist.) The converted data block is transmitted to a car A/V 4 controller C25 by the main controller 17. The transmitted data blocks are stored on a hard disk 30 one by one for each data block by operating controller C25. Therefore, if the car is driven when a portable phone 3 is not connected for telecommunication, the diagnosis data accumulated on a hard disk 30 is transferred to a storage unit 27 equipped on a portable phone 3 by connecting it to a car A/V 4 for communicating and transferring data in accordance with the car A/V's 4 navigation operation screen.

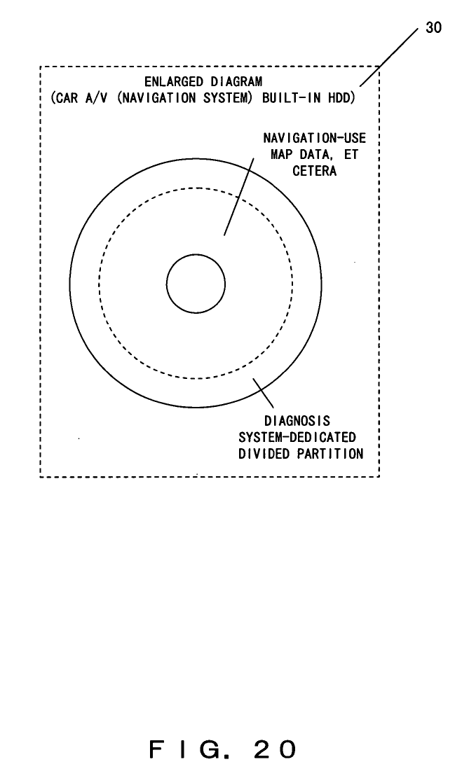

The following is a description of a transfer to a storage unit 27 equipped on a portable phone 3. The portable phone 3 is placed at a prescribed position and connected to a car A/V 4 for communication. Following this, by a car A/V 4 controller C25 extracts a data block that is attached with a time identifier which accumulates on a hard disk 30 in accordance with an instruction of a car A/V's 4 main controller 17. The data block is transmitted to a portable phone's 3 controller A26 in accordance with the main controller's 17 transmission/reception control. A controller A26, in accordance with an application software format, converts the transmitted data blocks, one by one. The transmitted data blocks are pre-stored in a large capacity storage unit 27 that controls the display(s) and data array(s) to be compatible with operations from the user's home PC. The transmitted data blocks are sequentially stored on a portable phone's 3 large capacity storage unit. The hard disk 30 accumulates diagnosis data on a diagnosis system dedicated-use partition zone in the same manner as the portable phone's 3 storage unit 27 as shown in FIG. 20. The remainder of the zone is configured to be a data zone for a non-diagnosis system so as to pre-store such information as navigation-use map data.

The service provision system of the second embodiment of the present invention is configured to make the navigation system's hard disk function as a diagnosis data storage medium in place of portable information equipment possessed by the user. From the customers' point of view, this configuration also enables equipment to be developed by taking advantage of the user's portable information equipment, eliminating telecommunication costs for the portable information equipment (as illustrated in the first embodiment), and enabling the car maker to use the present service provision system to obtain a large amount of data which can be utilized in the aftermarket. Particularly, when utilizing the service provision system (including diagnosis of the present invention for a business use), an individual's portable phone can be utilized and no telecommunication cost is required. Therefore, a business entity is not required to furnish a portable information equipment and is completely free from cumbersome office processes such as settling expense accounts regarding operation costs (e.g., a telecommunication expense). Thus it makes a convenient, user-friendly, service provision system.

The present invention is applicable to a service provision system that provides a diagnosis service for an operating condition of a user's mobile body. This invention includes a method for obtaining information related to the operation condition of a mobile body as well as information obtained from a navigation system and information obtained by the method. Additionally, this invention is configured to build up a database for a mobile body manufacturer and provide a service that is beneficial in building an alliance between affiliated companies.

The present invention is not only applicable to a user using a personal-use mobile body, but also to a user using a mobile body of a company such as a leasing company or taxi company.

What is claimed is:

1. A service provision system, at least comprising:
a portable information equipment being communicable with a car audio/video apparatus (A/V) equipped in a mobile body and having a storage medium for accumulating information related to an operating condition of the mobile body; and
a service provision entity for providing a service including a diagnosis of the mobile body based on the information accumulated in the storage medium of the portable information equipment, wherein
the service provision entity makes a service provision system introduction terminal install, in the portable information equipment, application software enabling a utilization of a service including a diagnosis of the mobile body and also makes the service provision system introduction terminal assign the user to a user identification information.

2. The service provision system according to claim 1, wherein
said service provision entity gives permission to install application software in said user terminal by using an ID and a password which are included in said user identification information in order to enable a utilization of a service including a diagnosis of said mobile body when a service provision contract with said user is established.

3. The service provision system according to claim 1, further comprising
a user terminal which installs various kinds of application software that is provided by a service provision entity for getting the information in the terminal by linking with said portable information equipment, wherein
the application software installed in the user terminal is updated to the latest version via a Web page of the service provision entity.

4. The service provision system according to claim 1, wherein
said information related to an operating condition of said mobile body and said information received from said navigation system are converted into an array compatible to said application software by the application software and accumulated on said storage medium equipped in said portable information equipment.

5. The service provision system according to claim 1, wherein
said application software, said information related to operating condition of said mobile body obtained from an in-vehicle sensor and said information received from said navigation system are stored in a specific partition zone divided in said storage medium equipped in said portable information equipment.

6. The service provision system according to claim 5, wherein
said storage medium equipped in said portable information equipment is a hard disk and said partition is set on an outer circumference part of the hard disk.

7. The service provision system according to either of claim 1, wherein
said service provision system introduction terminal comprises a unit for setting a partition in said storage medium equipped in said portable information equipment.

8. The service provision system according to claim 7, wherein
said service provision system introduction terminal comprises a unit for installing said application software in a dedicated zone of said set partition.

9. The service provision system according to claim 8, wherein
said service provision system introduction terminal comprises a transmission/reception unit for transmitting and receiving data to and from said portable information equipment, makes user data stored in said storage medium take shelter in a storage unit of the service provision system introduction terminal via the transmission/reception unit before setting said partition and installing said application software, re-places the user data in a different zone of the partition of said storage medium via the transmission/reception unit after setting the partition and installing the application software, and automatically erases the user data stored in the service provision system introduction terminal.

10. The service provision system according to claim 1, wherein,
if a service provision entity providing a service including a diagnosis of said mobile body has a business alliance with a non-life insurance company providing a vehicle insurance, the service provision entity assigns a special access code to the non-life insurance company enabling it to access to a customer management database of the service provision entity retaining a track record of diagnosis requests of a contract user who has subscribed to both of said diagnosis service and vehicle insurance, and
the non-life insurance company accesses to the customer management database of the service provision entity by using the access code.

11. The service provision system according to claim 10, wherein
said non-life insurance company refers to a track record of diagnosis requests of said contract user by accessing to said customer management database of said service provision entity, calculates an amount of refund of an insurance premium for the contract user by using the track record of diagnosis requests of the contract user as an indicator, and deposit the amount of the refund to an account designated by the contract user at the time of ending the contract, or signing up for a new contract, with the contract user.

12. A service provision system at least comprising a portable information equipment having a storage medium accumulating information obtained from a navigation system and a user terminal for getting the information in the terminal by linking with the portable information equipment, wherein
the portable information equipment stores photograph data photographed thereby and position data obtained from the navigation system in the storage medium as correlated data, and
the user terminal comprises a unit for making use of the correlated data in the terminal, displaying the latest and past travel paths and the existence of the photograph data photographed during the traveling in the travel path by a photography mark, and displaying an enlargement of the photograph data by a user clicking on the photography mark.

13. The service provision system according to claim 12, wherein
said user terminal comprises a unit for downloading application software for displaying said photography mark and enlarging said photograph data.

14. The service provision system according to claim 13, wherein
said application software is usable only when the user is accessing to a Web page of said service provision entity.

15. The service provision system according to claim 14, wherein
said application software manages so as not to transmit the process of a user editing or processing photograph data via a Web page by using the application software to said service provision entity.

16. The service provision system according to claim 1, wherein
said application software retains a unit capable of storing a piece(s) of data individually which is desirably stored in said user terminal, shifting to a transmission page for confirming transmission data for the data of which a diagnosis is to be requested, and transmitting the data following an editing and confirming it when said user requests said service provision entity for a diagnosis of said mobile body.

17. A service provision system at least comprising a portable information equipment having a storage medium accumulating information obtained from a navigation system and a user terminal for getting the information in the terminal by linking with the portable information equipment, wherein
the portable information equipment stores local information related to sightseeing and advertisement of a local area obtained from the navigation system in the storage medium as correlated data with position data, and the user terminal comprises a unit capable of browsing the local information by making use of the correlated data in the terminal.

18. The service provision system according to claim 17, wherein
said application software enabling a browsing of said local information is usable only when the user is accessing to a Web page of said service provision entity.

19. A portable information equipment, retaining
a storage medium, wherein
an information received from a navigation system and stored in the storage medium, comprising:
a unit for storing photographed photograph data and position data obtained from the navigation system in the storage medium as correlated information; and
a unit for transferring the correlated data to a user terminal.

20. A portable information equipment, retaining
a storage medium, wherein
an information received from a navigation system and stored in the storage medium, comprising:
a unit for storing local information related to sightseeing and advertisement of a local area obtained from the navigation system in the storage medium as correlated data with position data; and
a unit for transferring the correlated data to a user terminal.
